(19) United States
(12) Patent Application Publication
(10) Pub. No.: US 2015/0226900 A1
(43) Pub. Date: Aug. 13, 2015

(54) APPARATUS AND METHOD FOR MANUFACTURING LIGHT GUIDE PANEL

(71) Applicant: SAMSUNG DISPLAY CO., LTD., Yongin-City (KR)

(72) Inventor: Gi Cherl KIM, Asan-si (KR)

(73) Assignee: SAMSUNG DISPLAY CO., LTD., Yongin-City (KR)

(21) Appl. No.: 14/293,912

(22) Filed: Jun. 2, 2014

(30) Foreign Application Priority Data
Feb. 7, 2014 (KR) 10-2014-0014244

(51) Int. Cl. F21V 8/00; B26D 7/00; G02F 1/1335

(52) U.S. Cl. CPC G02B 6/0011; G02F 1/133524; B26D 7/0006

(57) ABSTRACT

An apparatus for manufacturing a light guide panel and a method for manufacturing a light guide panel are provided. An apparatus for manufacturing a light guide panel includes a first dummy plate arranged on an original plate for manufacturing a first light guide panel and a cutting device configured to cut the original plate for manufacturing the first light guide panel, wherein a lower surface of the first dummy plate includes a first concave portion in a position that corresponds to a position of a first convex portion arranged on an upper surface of the original plate for manufacturing the first light guide panel.

### CROSS-REFERENCE TO RELATED APPLICATIONS

This application is based on and claims priority from Korean Patent Application No. 10-2014-0014244, filed on Feb. 7, 2014 in the Korean Intellectual Property Office, the disclosure of which is incorporated herein in its entirety by reference.

### BACKGROUND

1. Field of the Invention

The present invention relates to an apparatus and method for manufacturing a light guide panel, and more particularly to an apparatus and method for manufacturing a light guide panel using an original plate for manufacturing the light guide panel.

2. Description of the Prior Art

A liquid crystal display includes a liquid crystal display module that is connected to an external case. The liquid crystal display module includes a liquid crystal panel that is composed of two substrates between which a liquid crystal layer is interposed, and a backlight assembly that is positioned in the rear of the liquid crystal panel to supply light to the liquid crystal layer. The liquid crystal panel displays an image through adjustment of permeability of light that is provided from the backlight assembly.

The backlight assembly is classified into a direct type and a photometric type depending on the position of light sources. In the direct type backlight assembly, light sources are provided in the rear of a display panel, and in the photometric type backlight unit, light sources are provided on one side of a rear portion of the display panel.

The photometric type backlight unit requires a light guide panel that guides light emitted from the light sources to the display panel side. The light guide panel guides the light to the display panel by changing a light path.

A method for manufacturing a light guide panel is briefly classified into an extrusion method and an injection method. The injection method forms a light guide panel by injecting a material into a predetermined mold. The extrusion method forms a light guide panel by forming a plate-shaped original plate for manufacturing a light guide panel through pressing a material using a pressing means and cutting the original plate. In the case of producing a light guide panel using the extrusion method, the original plates for manufacturing a light guide panel are cut one by one, and thus efficiency of the light guide panel production process is not high. Various technical attempts to solve the above-described problem have been made.

### SUMMARY

An apparatus for manufacturing a light guide panel, which can improve productivity of the light guide panel that is manufactured by an extrusion method is provided.

A method for manufacturing a light guide panel, which can improve productivity of the light guide panel that is manufactured by an extrusion method, is provided.

Additional advantages, subjects, and features will be set forth in part in the description which follows and in part will become apparent to those having ordinary skill in the art upon examination of the following or may be learned from practice of the disclosure.

In one aspect, an apparatus for manufacturing a light guide panel includes a first dummy plate arranged on an original plate for manufacturing a first light guide panel and a cutting device configured to cut the original plate for manufacturing the first light guide panel, wherein a lower surface of the first dummy plate includes a first concave portion in a position that corresponds to a position of a first convex portion arranged on an upper surface of the original plate for manufacturing the first light guide panel.

In another aspect, a method for manufacturing a light guide panel includes arranging an original plate for manufacturing a first light guide panel having an upper surface on which a first convex portion is formed, arranging a first dummy plate that includes a first concave portion in a position corresponding to the first convex portion on the original plate for manufacturing the first light guide panel, arranging an original plate for manufacturing a second light guide panel having an upper surface on which a second convex portion is formed on the first dummy plate, arranging a second dummy plate that includes a second concave portion in a position corresponding to a position of the second convex portion on the original plate for manufacturing the second light guide panel and forming a plurality of unit light guide panels by cutting the original plate for manufacturing the first light guide panel and the original plate for manufacturing the second light guide panel along cutting lines defined on the first dummy plate and the second dummy plate.

Accordingly, at least the following effects can be achieved.

That is, since a plurality of original plates for manufacturing a light guide panel can be simultaneously cut, the productivity of the light guide panel can be improved.

The effects are not limited to the contents as exemplified above, but further various effects are included in the description.

### BRIEF DESCRIPTION OF THE DRAWINGS

The above and other objects, features and advantages of the present disclosure will be more apparent from the following detailed description taken in conjunction with the accompanying drawings, in which:

FIG. 1 is a partial perspective view of an apparatus for manufacturing a light guide panel according to an embodiment;

FIG. 2 is a partial perspective view of the apparatus for manufacturing a light guide panel of FIG. 1;

FIG. 3 is a partial cross-sectional view of a dummy plate of the apparatus for manufacturing a light guide panel of FIG. 1;

FIG. 4 is a partial perspective view of an apparatus for manufacturing a light guide panel according to another embodiment;

FIG. 5 is a partial perspective view of an apparatus for manufacturing a light guide panel according to still another embodiment;

FIG. 6 is a partial perspective view of an apparatus for manufacturing a light guide panel according to still another embodiment; and

FIGS. 7 to 12 are partial perspective views illustrating a method for manufacturing a light guide panel according to an embodiment.

### DETAILED DESCRIPTION OF THE EMBODIMENTS

The aspects and features of the present disclosure and methods for achieving the aspects and features will be apparent by referring to the embodiments to be described in detail with reference to the accompanying drawings. However, the present invention is not limited to the embodiments disclosed hereinafter, but can be implemented in diverse forms. The matters defined in the description, such as the detailed construction and elements, are details provided to assist those of ordinary skill in the art in understanding of the disclosure.

The term “on” that is used to designate that an element is on another element or located on a different layer or a layer includes both a case where an element is located directly on another element or a layer and a case where an element is located on another element via another layer or still another element. In the entire description of the present invention, the same drawing reference numerals are used for the same elements across various figures.

Although the terms “first, second, and so forth” are used to describe diverse constituent elements, such constituent elements are not limited by the terms. The terms are used only to discriminate a constituent element from other constituent elements. Accordingly, in the following description, a first constituent element may be a second constituent element.

Hereinafter, embodiments will be described with reference to the accompanying drawings.

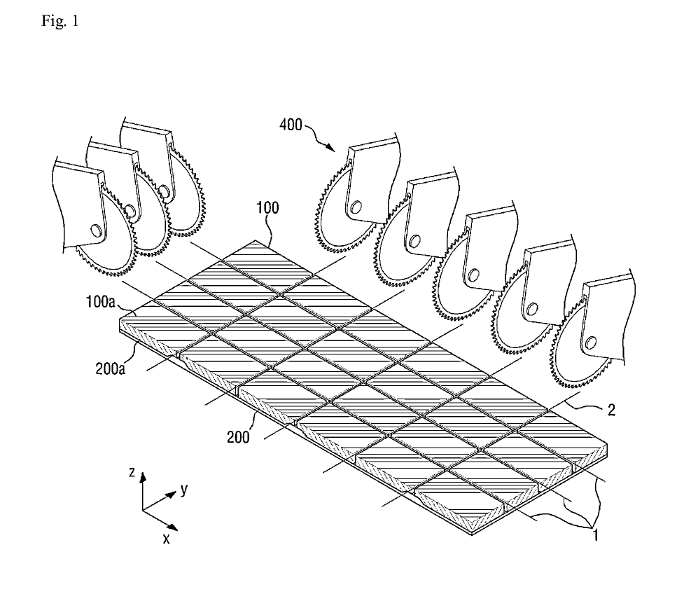

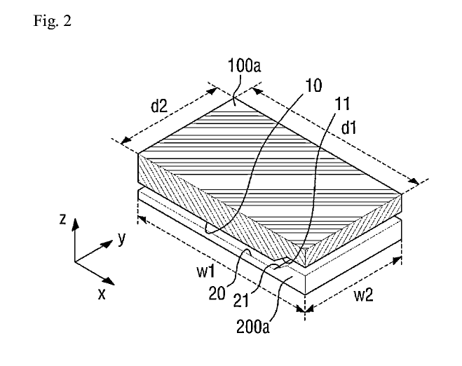

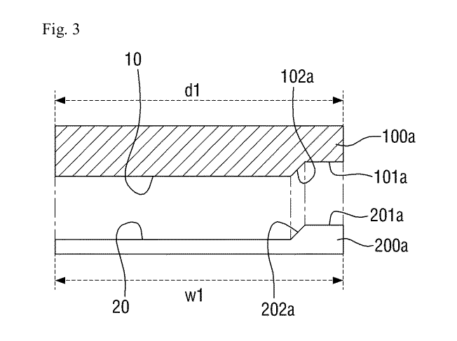

FIG. 1 is a partial perspective view of an apparatus for manufacturing a light guide panel according to an embodiment. FIG. 2 is a partial perspective view of the apparatus for manufacturing a light guide panel of FIG. 1, and FIG. 3 is a partial cross-sectional view of a dummy plate of the apparatus for manufacturing a light guide panel of FIG. 1.

Referring to FIGS. 1 to 3, an apparatus for manufacturing a light guide panel according to an embodiment includes a first dummy plate 100 arranged on an original plate 200 for manufacturing a first light guide panel, e.g. 200a, and a cutting device 400, e.g. scriber cutting the original plate 200 for manufacturing the first light guide panel, in which a lower surface of the first dummy plate 100 includes a first concave portion 11 (FIG. 2) that corresponds to a first convex portion 21 (FIG. 2) arranged on an upper surface of the original plate 200 for manufacturing the first light guide panel 200a.

The first dummy plate 100 is the dummy plate that is used to manufacture a plurality of unit light guide panels 200a using the original plate 200 for manufacturing the first light guide panel, and includes a plurality of unit dummy plates 100a. The unit dummy plate 100a includes the first concave portion 11 that corresponds to the first convex portion 21 formed on the upper surface of the original plate 200 for manufacturing the first light guide panel.

The original plate 200 for manufacturing the first light guide panel 200a refers to the original plate for manufacturing the plurality of unit light guide panels 200a. That is, the plurality of unit light guide panels 200a can be obtained by cutting the original plate 200 in x-axis direction and/or in y-axis direction. In an example embodiment, the original plate 200 for manufacturing the first light guide panel may be formed by an extrusion method.

In order to manufacture a light guide panel that is formed by the extrusion method, it is necessary to first perform a process of producing the original plate 200 for manufacturing the light guide panel using a material that forms the light guide panel and a pressing means. The original plate 200 for manufacturing the light guide panel may be manufactured using, for example, polycarbonate (PC) or polyethylenetherephthalate (PET) as a raw material. However, the material of the original plate 200 for manufacturing the light guide panel is not limited thereto. As an example, the pressing means may be pressure rollers that are arranged on upper and lower sides. That is, the original plate for manufacturing the light guide panel may be manufactured through the medium of the material of the original plate 200 for manufacturing the light guide panel between the pressure rollers. However, this is merely one example, and the method for manufacturing the original plate for manufacturing the light guide panel is not limited thereto. If the original plate for manufacturing the light guide panel is formed by the extrusion method, a thin light guide panel can be obtained. That is, in the case where the light guide panel is formed by an injection method, it is technically difficult to form a large-area light guide panel with a thickness of 0.4 mm or less. In the case of manufacturing a light guide panel by the extrusion method, it becomes possible to form a large-area light guide panel with a thickness of 0.4 mm or less. The explanation of the manufacturing of the original plate 200 as described above does not limit the scope of the present invention.

The original plate 200 for manufacturing the first light guide panel may include a plurality of unit light guide panels 200a. In other words, the plurality of unit light guide panels 200a can be obtained by cutting the original plate 200 for manufacturing the first light guide panel.

Referring to FIG. 2, an upper surface of the original plate 200 for manufacturing the first light guide panel may include a first reference surface portion 20 and a first convex portion 21 formed to project from the first reference surface portion 20. That is, the first convex portion 21 included in the original plate 200 for manufacturing the first light guide panel may be formed on an upper surface of each unit light guide panel 200a. The first reference surface portion 20 is a flat surface, and may be a reference surface with respect to projection and recess portions. The convex portion 21 may be formed to project, i.e., protrude upward, from the first reference surface portion 20 of the original plate 200 for manufacturing the first light guide panel. The convex portion 21 may be formed by deformation of the physical shape for each unit light guide panel 200a to perform a specific function. That is, in order to improve the performance of the unit light guide panel 200a, at least one convex portion 21, which projects from the first reference surface portion 20, may be formed on the upper surface of the unit light guide panel 200a. In other words, in the description, the convex portion 21 may be understood as the concept that includes all kinds of projection shapes formed to project from the first reference surface portion 20 of the original plate 200 for manufacturing the first light guide panel.

The first dummy plate 100 may be arranged on the upper portion of the original plate 200 for manufacturing a first light guide panel. The first dummy plate 100 may include a plurality of unit dummy plates 100a that are separate from each other. The plurality of unit dummy plates 100a may correspond to the respective unit light guide panels 200a. That is, one unit light guide panel 200a corresponds to one unit dummy plate 100a, and one unit dummy plate 100a may be arranged on an upper portion of one unit light guide panel 200a, and each dummy plat 100a is positioned to be adjacent to but separated from other dummy plates 100a.

The first dummy plate 100 may be formed of a rigid material. As an example, the first dummy plate 100 may be formed of a metal material, but the material of the first dummy plate 100 is not limited thereto.

A lower surface of the first dummy plate 100 and an upper surface of the original plate 200 for manufacturing the first light guide panel may come in contact with each other. That is, the lower surface of the first dummy plate 100 may come in contact with the upper surface of the original plate 200 for manufacturing the first light guide panel, and the first dummy plate 100 and the original plate 200 for manufacturing the first light guide panel may be successively laminated.

In an example embodiment, the horizontal and vertical widths of the first dummy plate 100 may be substantially the same as the horizontal and vertical widths of the original plate 200 for manufacturing the first light guide panel, but are not limited thereto. In another example embodiment, the horizontal and vertical widths of the first dummy plate 100 may be smaller than the horizontal and vertical widths of the original plate 200 for manufacturing the first light guide panel. In an example embodiment, a case where the horizontal and vertical widths of the first dummy plate 100 are smaller than the horizontal and vertical widths of the original plate 200 for manufacturing the first light guide panel will be described in detail later.

The lower surface of the first dummy plate 100 may include a second reference surface portion 10 and a concave portion 11 that is formed to be recessed from the second reference surface portion 10.

The second reference surface portion 10 is a flat surface, and may be a reference surface with respect to projection and recess portions. The concave portion 11 may be formed to be recessed from the second reference surface portion 10 to the upper surface of the first dummy plate 100. The concave portion 11 may be formed to correspond to the first convex portion 21 formed on the original plate 200 for manufacturing the first light guide panel. That is, the first convex portion 21 formed on the original plate 200 for manufacturing the first light guide panel and the first concave portion 11 of the first dummy plate 100 may come in contact with each other to be engaged with each other. In other words, the degree, i.e., amount, of recess of the first concave portion 11 of the first dummy plate 100 may be substantially equal to the degree of projection of the first convex portion 21 of the original plate 200 for manufacturing the first light guide panel. That is, the first convex portion 21 formed on the original plate 200 for manufacturing the first light guide panel and the first concave portion 11 of the first dummy plate 100 come in contact with each other to be engaged with each other, and thus the upper surface of the first dummy plate 100 may be horizontally arranged.

Hereinafter, referring to FIGS. 2 and 3, the unit dummy plate 100a and the corresponding unit light guide panel 200a will be described in more detail.

As described above, the unit dummy plate 100a may have a shape that corresponds to the unit light guide panel 200a. That is, the shape of the unit light guide panel 200a conforms to, or fits into, the shape of the unit dummy plate 100a. Accordingly, an example shape of the unit light guide panel 200a will be first explained, and then the corresponding unit dummy plate 100a will be explained.

The unit light guide panel 200a may include an upper surface, a lower surface, and four side surfaces. One of the four side surfaces may be a light incident surface. Another side surface that is opposite to the light incident surface may be called an opposite surface.

The width w1 of the lower surface of the unit light guide panel 200a may be substantially equal to the width d1 in the horizontal direction of the upper surface of the unit light guide panel 200a. In an example embodiment, a plurality of scattering patterns (not illustrated) may be formed on the unit light guide panel 200a. The plurality of scattering patterns may be substantially equal to a plurality of scattering patterns that are known in the art.

The thickness of the light incident surface that is arranged on one side surface of the unit light guide panel 200a may be different from the thickness of the opposite surface that is arranged on the other side surface of the unit light guide panel 200a. That is, even if the thickness of the unit light guide panel 200a that is formed by the extrusion method becomes thin, the size of the light source portion that irradiates light onto the light incident surface may not be thinned as much as the thickness of the unit light guide panel 200a. That is, in order to minimize light loss by making the thickness of the light incident surface to the same as the size of the light source portion, the thickness of the light incident surface may be set to be relatively larger than the thickness of the opposite surface.

Through this, the first convex portion 21 may be formed on the unit light guide panel 200a. That is, in an example embodiment, the first convex portion 21 of the unit light guide panel 200a may include a first reference surface portion 20, a first inclined surface portion 202a upwardly inclined from an end portion of the first reference surface portion 20, and a first flat surface portion 201a formed to extend in the horizontal direction from an upper end of the first inclined surface portion 202a. That is, the level of the first flat surface portion 201a may be relatively higher than the level of the first reference surface portion 20. That is, the light incident surface that will face the light source portion may be formed to extend vertically downward from an end portion of the first flat surface portion 201a.

In an example embodiment in which the convex portion 21 of the unit light guide panel 200a includes the first reference surface portion 20, the first inclined surface portion 202a upwardly inclined from the end portion of the first reference surface portion 20, and the first flat surface portion 201a formed to extend in the horizontal direction from the upper end of the first inclined surface portion 202a, the unit dummy plate 100a may have the first concave portion 11 that corresponds to, i.e., is conformed to the shape of, the first convex portion. Specifically, the unit dummy plate 100a may include a second reference surface portion 10 that corresponds to the first reference surface portion 20, a second inclined surface portion 102a that corresponds to the first inclined surface portion 202a, and a second flat surface portion 101a that corresponds to the first flat surface portion. In other words, the first concave portion of the unit dummy plate 100a may include the second inclined surface portion 102a and the second flat surface portion 101a.

The horizontal and vertical widths of the portions that correspond to each other may be substantially equal to each other. That is, the horizontal and vertical widths of the first and second reference surface portions 20 and 10, the first and second inclined surface portions 202a and 102a, and the first and second flat surface portions 201a and 101a may be substantially equal to each other.

As illustrated in FIGS. 2 and 3, the horizontal width d1 of the upper surface of the unit dummy pattern 100a, the horizontal width w1 of the lower surface of the unit light guide panel 200a, the vertical width d2 of the upper surface of the unit dummy pattern 100a, and the vertical width w2 of the lower surface of the unit light guide panel 200a may be substantially equal to each other. To be described later, a cutting line for cutting the original plate 200 for manufacturing the light guide panel may be defined between one unit dummy pattern 100a and other adjacent unit dummy patterns. That is, a specific cutting device 400 may cut the original plate 200 for manufacturing the light guide panel along the cutting lines 1 and 2 which run between the individual unit dummy patterns 100a that collectively form dummy plate 100. Accordingly, the cutting device 400 may be interposed in a space between the adjacent unit dummy patterns 100a, and in an example embodiment, the thickness of the cutting device 400 may be small enough to be disregarded in comparison to the horizontal width d1 of the upper surface of the unit dummy pattern 100a, the horizontal width w1 of the lower surface of the unit light guide panel 200a, the vertical width d2 of the upper surface of the unit dummy pattern 100a, and the vertical width w2 of the lower surface of the unit light guide panel 200a. That is, in the description, the expression “substantially equal to” may be understood as the concept that includes a difference that is small enough to be disregarded.

As described above, the first dummy plate 100 may include a plurality of unit dummy plates 100a. The plurality of unit dummy plates 100a may be arranged in the form of a matrix having a plurality of rows and columns. Further, the plurality of unit dummy plates 100a may be spaced apart from each other by a predetermined distance. A plurality of cutting lines may be defined as the spaces between the plurality of unit dummy plates 100a. That is, as illustrated in FIG. 1, a plurality of first cutting lines 1 that are in parallel to the x axis and a plurality of second cutting lines 2 that are in parallel to the y axis may be defined. That is, the first cutting lines 1 and the second cutting lines 2 may be defined as the space between one unit dummy plate 100a and another adjacent unit dummy plate 100a, and the original plate for manufacturing the light guide panel may be cut along the first cutting lines 1 and the second cutting lines 2. If the original plate 200 for manufacturing the light guide panel is cut along the first cutting lines 1 and the second cutting lines 2, a plurality of unit light guide panels 200a may be formed. That is, the cutting device 400 may be inserted in the first cutting lines 1 and the second cutting lines 2, and by the cutting device 400 inserted in the first cutting lines 1 and the second cutting lines 2, the original plate 200 for manufacturing the first light guide panel is cut to form the unit light guide panels 200a. Herein, the plurality of unit light guide panels 200a may be fixed on the original plate 200 for manufacturing the first light guide panel the by a fixing means (not shown) when the original plate 200 for manufacturing the first light guide panel is cut.

FIG. 1 illustrates as an example a case where the cutting device cuts the original plate 200 for manufacturing the first light guide panel and an original plate 250 for manufacturing a second light guide panel using a scribing method. However, this is an example, and the method that is adopted by the cutting device is not limited thereto. In another example embodiment, the cutting device may include a blade cutter or a laser beam irradiating device, and using this, the cutting device may cut the original plate 200 for manufacturing the first light guide panel. That is, the scope of the present disclosure is not limited by the kinds of the cutting devices.

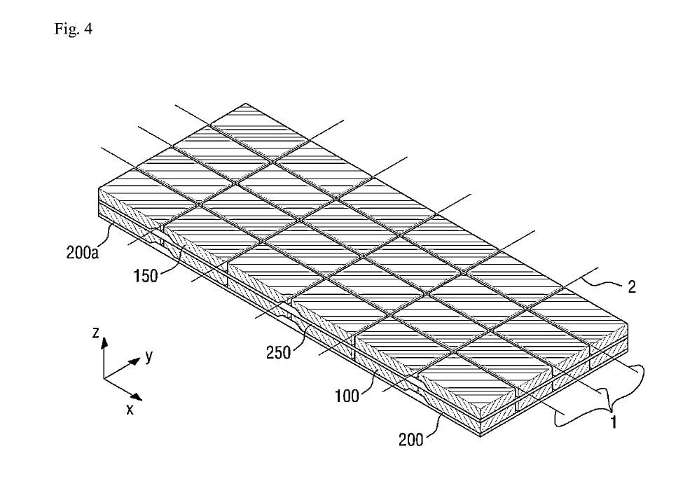

As described above, if the first dummy plate 100, which includes the first concave portion corresponding to the first convex portion that is formed on the original plate 200 for manufacturing the first light guide panel, is arranged, the upper surface of the first dummy plate 100 may be horizontally arranged. That is, the upper surface of the first dummy plate 100 may be a flat surface that extends in the horizontal direction. If the upper surface of the first dummy plate 100 is the flat surface that extends in the horizontal direction, another original plate for manufacturing a light guide panel may be arranged on the first dummy plate 100. This will be described in detail with reference to FIG. 4.

FIG. 4 is a partial perspective view of an apparatus for manufacturing a light guide panel according to another embodiment.

Referring to FIG. 4, the apparatus for manufacturing a light guide panel according to another embodiment is different from the apparatus for manufacturing a light guide panel according to the embodiment illustrated in FIG. 1 on the point that the apparatus according to this embodiment further include a second dummy plate 150 arranged on the original plate 200 for manufacturing the first light guide panel that is arranged on the first dummy plate 100.

That is, the first dummy plate 100 may be arranged on the original plate 200 for manufacturing the first light guide panel, and an original plate 250 for manufacturing a second light guide panel may be arranged on the first dummy plate 100. Further, the second dummy plate 150 may be arranged on the original plate 250 for manufacturing the second light guide panel. In this case, unit dummy plates of the first dummy plate 100 may be arranged in parallel to unit dummy plates of the second dummy plate 150. That is, the unit dummy plates of the first dummy plate 100 may completely overlap the unit dummy plates of the second dummy plate 150. In other words, the first cutting line 1 and the second cutting line 2 that are formed on the first dummy plate 100 may overlap the first cutting line 1 and the second cutting line 2 that are formed on the second dummy plate 150. That is, the first cutting line 1 and the second cutting line 2 that are formed on the first dummy plate 100 and the first cutting line 1 and the second cutting line 2 that are formed on the second dummy plate 150 may be arranged on a straight line. In other words, the first cutting line 1 and the second cutting line 2 that are formed on the first dummy plate 100 may coincide with the first cutting line 1 and the second cutting line 2 that are formed on the second dummy plate 150. The original plate 200 for manufacturing the first light guide panel and the original plate 250 for manufacturing the second light guide panel are cut together along the first cutting line 1 and the second cutting line 2 formed on the first dummy plate 100 and the second dummy plate 150 to form a plurality of unit light guide panels 200a having substantially the same shape.

FIG. 4 is an example of a case where the two original plates for manufacturing the light guide panels are laminated by the two dummy plates, but the number of the original plates for manufacturing the light guide panels being laminated is not limited thereto. That is, two or more original plates for manufacturing the light guide panels may be laminated by two or more dummy plates. In other words, the plurality of original plates for manufacturing the light guide panels may be laminated in the order of the original plate for manufacturing the light guide panel, the dummy plate, the original plate for manufacturing the light guide panel, and the dummy plate. In the case of cutting the original plates along the first cutting line and the second cutting line in a state where the plurality of original plates are laminated as described above, a plurality of unit light guide panels can be obtained. In the case of laminating the plurality of original plates for manufacturing the light guide panels using the dummy plates according to some embodiments and forming the plurality of unit light guide panels through simultaneous cutting of the laminated original plates, the productivity of the unit light guide panels can be relatively improved as compared with a case where one original plate for manufacturing the light guide panel is used or a case where the light guide panels are produced through the injection method.

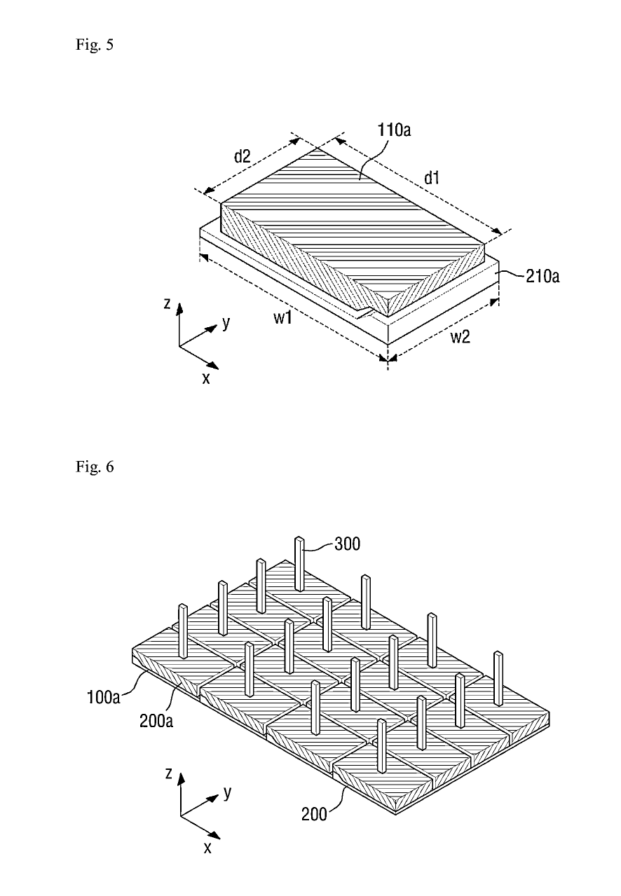

FIG. 5 is a partial perspective view of an apparatus for manufacturing a light guide panel according to still another embodiment.

Referring to FIG. 5, the apparatus for manufacturing a light guide panel according to still another embodiment is different from the apparatus for manufacturing a light guide panel according to the embodiment illustrated in FIG. 1 on the point that the horizontal width d1 and the vertical width d2 of the first unit dummy plate 110a are relatively smaller than the horizontal width w1 and the vertical width w2 of the unit light guide panel 210a, respectively.

The horizontal width d1 and the vertical width d2 of the first unit dummy plate 110a may be relatively smaller than the horizontal width w1 and the vertical width w2 of the unit light guide panel 210a, respectively. As described above, cutting lines may be defined between the individual dummy plates 110a, which are adjacent to each other, but have more space between each other as compared to the embodiment illustrated in FIG. 1. A cutting device 400 may be inserted in the cutting lines, and by repeating the cutting process, the unit dummy plate may be damaged due to frictional force acting between the cutting device 400 and the unit dummy plate.

If the horizontal width d1 and the vertical width d2 of the unit dummy plate 110a are relatively smaller than the horizontal width w1 and the vertical width w2 of the unit light guide panel 210a, the frictional force acting between the unit dummy plate 110a and the cutting device 400 can be reduced to prevent the unit dummy plate 110a from being damaged.

FIG. 6 is a partial perspective view of an apparatus for manufacturing a light guide panel according to still another embodiment.

Referring to FIG. 6, the apparatus for manufacturing a light guide panel according to still another embodiment is different from the apparatus for manufacturing a light guide panel according to the embodiment illustrated in FIG. 1 on the point that the apparatus according to this embodiment further include a fixing portion fixing the unit dummy plates.

In an example embodiment, the apparatus for manufacturing the light guide panel may further include a fixing portion fixing the plurality of unit dummy plates. The fixing portion 300 is a pressing means, and may apply pressure to the unit dummy plates 100a. If the fixing portion 300 applies pressure from an upper portion to a lower portion of the unit dummy plate 100a, the unit dummy plates 100a and the original plate 200 for manufacturing the light guide panel are firmly fixed, and thus positions of the unit dummy plates 100a can be prevented from mismatching during a cutting process to prevent the occurrence of inferiority.

Further, in the case where a plurality of fixing portions 300 press the center portions of the respective unit dummy plates 100a to fix the unit dummy plates 100a as illustrated in FIG. 6, the fixing portions may not disturb traveling of the cutting device 400 to perform a cutting process.

However, the fixing portion 300 illustrated in FIG. 6 is one example, and the kind of the fixing portion 300 is not limited thereto. In another example embodiment, the fixing portion 300 may include another fixing means, such as a clamp.

Hereinafter, a method for manufacturing a light guide panel according to an embodiment will be described. The method for manufacturing the light guide panel according to an embodiment may be performed by the apparatuses for manufacturing the light guide panel according to embodiments described herein. However, the range of the method for manufacturing the light guide panel according to an embodiment is not limited thereto.

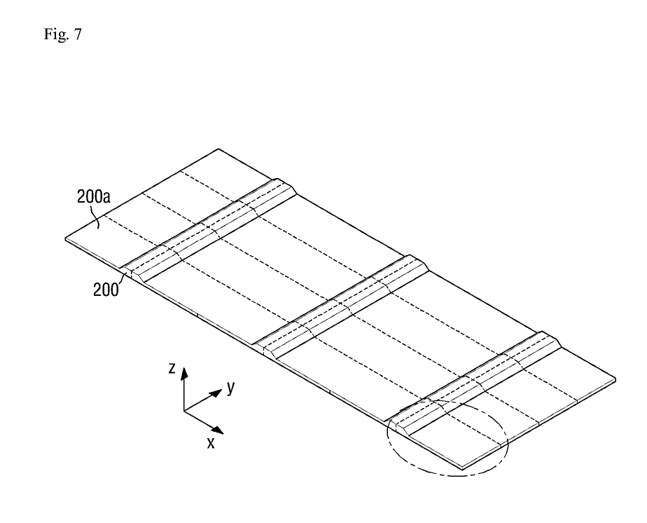

The method for manufacturing the light guide panel will be described with reference to FIGS. 7 to 12.

FIGS. 7 to 12 are partial perspective views illustrating a method for manufacturing a light guide panel according to an embodiment.

Referring to FIGS. 7 to 12, the method for manufacturing the light guide panel according to an embodiment includes arranging an original plate 200 for manufacturing a first light guide panel having an upper surface on which a first convex portion 21 is formed, arranging a first dummy plate 100 that includes a first concave portion 11 corresponding to the first convex portion 21 on the original plate for manufacturing the first light guide panel, arranging an original plate 250 for manufacturing a second light guide panel having an upper surface on which a second convex portion is formed on the first dummy plate, arranging a second dummy plate 150 that includes a second concave portion corresponding to the second convex portion on the original plate for manufacturing the second light guide panel, and
forming a plurality of unit light guide panels 200a by cutting the original plate 200 for manufacturing the first light guide panel and the original plate 250 for manufacturing the second light guide panel along cutting lines defined on the first dummy plate and the second dummy plate.

Referring to FIG. 7, an original plate 200 for manufacturing a first light guide panel having an upper surface on which a first convex portion is formed is arranged.

The original plate 200 for manufacturing the first light guide panel may be substantially the same as those in the apparatuses for manufacturing the light guide panel according to some embodiments. Accordingly, redundant explanation thereof will be omitted.

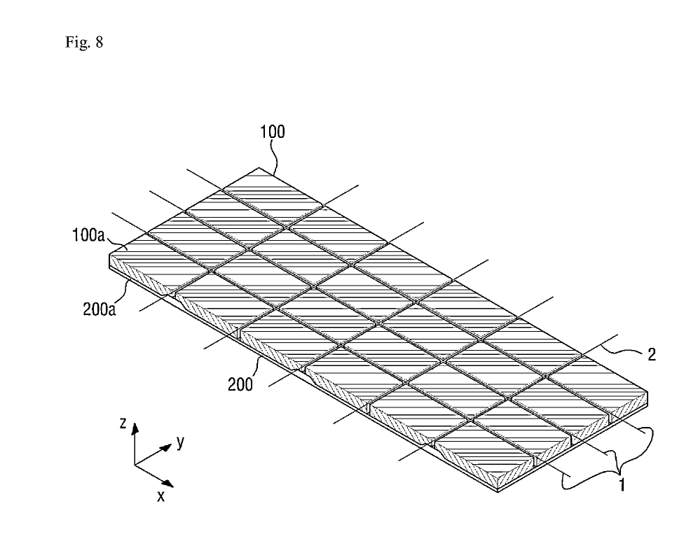

Referring to FIG. 8, a first dummy plate that includes a first concave portion corresponding to the first convex portion is arranged on the original plate 100 for manufacturing the first light guide panel.

As described above, the first dummy plate 100 may include a plurality of unit dummy plates 100a. Further, the plurality of unit dummy plates 100a may be arranged to be spaced apart from each other, and thus a plurality of cutting lines may be defined on the first dummy plate 100. In an example embodiment in which the unit dummy plate 100a is in a rectangular shape as illustrated in FIG. 8, the cutting lines may include a first cutting line 1 that is parallel to the x-axis direction and a second cutting line 2 that is parallel to the y-axis direction.

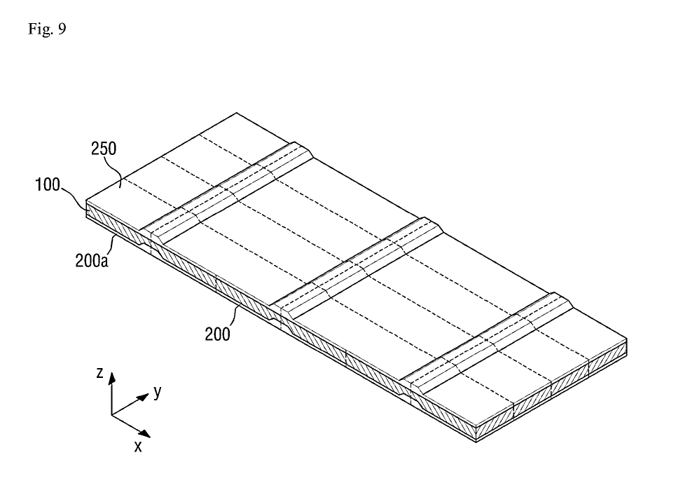

Referring to FIG. 9, an original plate 250 for manufacturing a second light guide panel having an upper surface on which a second convex portion is formed is arranged on the first dummy plate 100 after the first dummy plate including the first concave portion that corresponds to the first convex portion is arranged on the original plate 100 for manufacturing the first light guide panel.

The original plate 250 for manufacturing the second light guide panel and the second convex portion may be substantially the same as the original plate 100 for manufacturing the first light guide panel and the first convex portion. Accordingly, redundant explanation thereof will be omitted.

If the concave portion of the first dummy plate 100 and the convex portion of the original plate 200 for manufacturing the first light guide panel come in complementary contact with each other, the upper surface of the first dummy plate 100 may be horizontal. Accordingly, the original plate 250 for manufacturing the second light guide panel may be arranged on the upper surface of the first dummy plate 100. The original plate 250 for manufacturing the second light guide panel may be arranged in parallel to the original plate 200 for manufacturing the first light guide panel. That is, the original plate 200 for manufacturing the first light guide panel and the original plate 250 for manufacturing the second light guide panel, which have substantially the same shape, may accurately overlap each other.

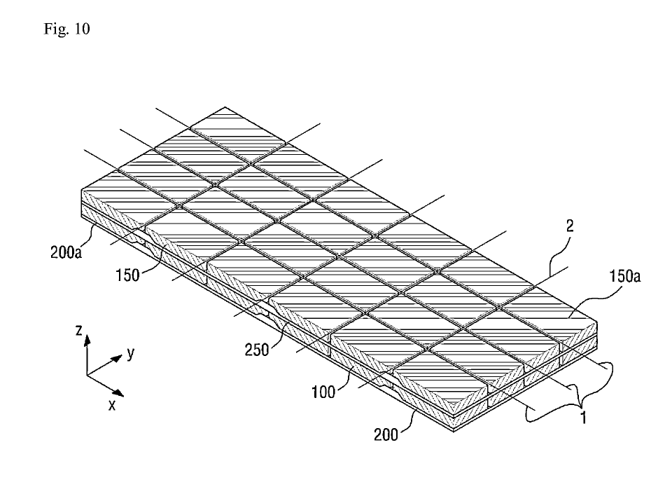

Referring to FIG. 10, a second dummy plate 150 that includes a second concave portion corresponding to the second convex portion is arranged on the original plate 250 for manufacturing the second light guide panel.

The second dummy plate 150 may have substantially the same shape as the first dummy plate 100.

The second dummy plate 150 may include a plurality of unit dummy plates 150a. Further, the plurality of unit dummy plates 150a may be arranged to be spaced apart from each other, and thus a plurality of cutting lines may be defined on the second dummy plate 150. As illustrated in FIG. 10, the cutting lines may include a first cutting line 1 that is parallel to the x-axis direction and a second cutting line 2 that is parallel to the y-axis direction. Further, the first cutting line 1 and the second cutting line 2, which are formed on the second dummy plate 150 and the first dummy plate 100, may completely overlap each other. That is, the first cutting line 1 and the second cutting line 2 that are formed on the second dummy plate 150 may completely coincide with the first cutting line 1 and the second cutting line 2 that are formed on the first dummy plate 100.

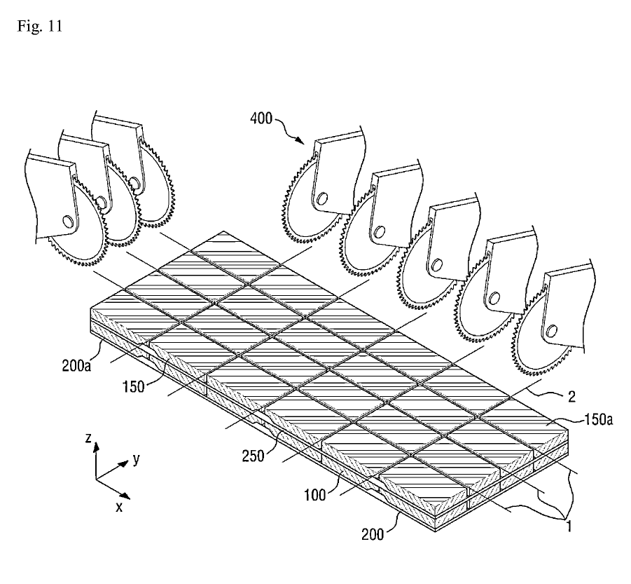

Referring to FIG. 11, a plurality of unit light guide panels are formed by cutting the original plate for manufacturing the first light guide panel and the original plate for manufacturing the second light guide panel along cutting lines defined on the first dummy plate and the second dummy plate.

The original plate 200 for manufacturing the first light guide panel and the original plate 250 for manufacturing the second light guide panel may be simultaneously cut along the cutting lines formed on the first dummy plate 100 and the second dummy plate 150. That is, a plurality of unit light guide panels having substantially the same shape may be manufactured by cutting the original plate 200 for manufacturing the first light guide panel and the original plate 250 for manufacturing the second light guide panel.

FIG. 11 exemplarily illustrates a case where the original plate 200 for manufacturing the first light guide panel and the original plate 250 for manufacturing the second light guide panel are cut using a scribing method. However, this is merely exemplary, and the cutting method is not limited thereto. That is, the original plate 200 for manufacturing the first light guide panel and the original plate 250 for manufacturing the second light guide panel may be cut using a blade cutter (not shown) that extends along the cutting lines or laser (not shown).

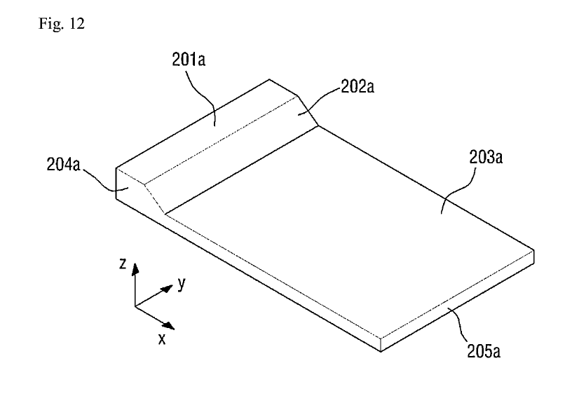

FIG. 12 illustrates as an example a unit light guide panel that is manufactured using the above-described method. That is, a plurality of unit light guide panels as shown in FIG. 12 may be formed by laminating at least one original plate for manufacturing the light guide panel using the dummy plate and then cutting the original plate for manufacturing the light guide panel simultaneously. If the light guide panel is manufactured in the above-described method, the productivity of the light guide panel that is formed in the extrusion method can be improved. That is, by simultaneously cutting several sheets of original plates for manufacturing the light guide panel, the number of manufactured light guide panels can be increased. Further, although it is exemplified that two original plates for manufacturing the light guide panel are laminated and cut, the scope of the present disclosure is not limited thereto. That is, two or more original plates for manufacturing the light guide panel may be laminated using two or more dummy plates and then may be simultaneously cut.

The method for manufacturing the light guide panel according to an embodiment may further include polishing the original plate 200 for manufacturing the first light guide panel 200a and the original plate 250 for manufacturing the second light guide panel after the original plate for manufacturing the first light guide panel and the original plate for manufacturing the second light guide panel are cut along the cutting lines defined on the first dummy plate and the second dummy plate.

After the plurality of unit light guide panels are formed by cutting the original plate for manufacturing the first light guide panel and the original plate for manufacturing the second light guide panel along the cutting lines defined on the first dummy plate and the second dummy plate, side surfaces of the unit light guide panels may be polished by inserting a polishing device between the first cutting line and the second cutting line. The polishing of the side surfaces of the unit light guide panels may be performed by inserting the polishing device in the first cutting line 1 and/or the second cutting line 2. That is, the polishing device having a thickness that corresponds to the width of the first cutting line 1 and the second cutting line 2 may be inserted between the first cutting line 1 and the second cutting line 2, and the side surfaces of the original plate for manufacturing the first light guide panel and the original plate for manufacturing the second light guide panel may be polished by driving the polishing device. In the case of polishing the original plate 200 for manufacturing the first light guide panel and the original plate 250 for manufacturing the second light guide panel, which are fixed by the first dummy plate 100 and the second dummy plate 150, in the above-described method, the polishing of the side surfaces of the plurality of unit light guide panels can be collectively performed, and thus time and cost required for the polishing work can be saved.

Although example embodiments have been described for illustrative purposes, those skilled in the art will appreciate that various modifications, additions and substitutions are possible, without departing from the scope and spirit of the disclosure, including the accompanying claims.

What is claimed is:

1. An apparatus for manufacturing a light guide panel comprising:
a first dummy plate arranged on an original plate for manufacturing a first light guide panel; and
a cutting device configured to cut the original plate for manufacturing the first light guide panel,
wherein a lower surface of the first dummy plate includes a first concave portion in a position that corresponds to a position of a first convex portion arranged on an upper surface of the original plate for manufacturing the first light guide panel.

2. The apparatus of claim 1, wherein the original plate for manufacturing the first light guide panel includes a plurality of unit light guide panels, and the first dummy plate includes a plurality of unit dummy plates that correspond to the unit light guide panels.

3. The apparatus of claim 2, wherein the unit dummy plates are arranged to be spaced apart from each other.

4. The apparatus of claim 3, wherein a first cutting line provided in a direction that is parallel to an x-axis and a second cutting line provided in a direction that is parallel to a y-axis are defined between the plurality of unit dummy plates, and the cutting device cuts the original plate for manufacturing the first light guide panel along the first cutting line and the second cutting line.

5. The apparatus of claim 2, wherein the first convex portion is formed on an upper surface of each of the unit light guide panels, and the first concave portion is formed on a lower surface of each of the unit light guide panels.

6. The apparatus of claim 5, wherein the first convex portion includes a first inclined surface portion and a first flat surface portion formed to extend from an upper end of the first inclined surface portion, and the first concave portion includes a second inclined surface portion in a position corresponding to a position of the first inclined surface portion and a second flat surface portion in a position corresponding to a position of the first flat surface portion.

7. The apparatus of claim 2, further comprising a fixing portion configured to fix the unit dummy plates and the unit light guide panels by pressing the unit dummy plates.

8. The apparatus of claim 1, further comprising a second dummy plate that is arranged on an original plate for manufacturing a second light guide panel arranged on the first dummy plate.

9. The apparatus of claim 8, wherein the second dummy plate includes a plurality of unit dummy plates, and the unit dummy plates of the second dummy plate and the unit dummy plates of the first dummy plate completely overlap each other.

10. The apparatus of claim 9, wherein a first cutting line provided in a direction that is parallel to an x-axis and a second cutting line provided in a direction that is parallel to a y-axis are defined between the unit dummy plates of the second dummy plate, and a first cutting line and a second cutting line of the first dummy plate overlap a first cutting line and a second cutting line of the second dummy plate.

11. A method for manufacturing a light guide panel comprising:
arranging an original plate for manufacturing a first light guide panel having an upper surface on which a first convex portion is formed;
arranging a first dummy plate that includes a first concave portion in a position corresponding to a position of the first convex portion on the original plate for manufacturing the first light guide panel;
arranging an original plate for manufacturing a second light guide panel having an upper surface on which a second convex portion is formed on the first dummy plate;
arranging a second dummy plate that includes a second concave portion in a position corresponding to a position of the second convex portion on the original plate for manufacturing the second light guide panel; and
forming a plurality of unit light guide panels by cutting the original plate for manufacturing the first light guide panel and the original plate for manufacturing the second light guide panel along cutting lines defined on the first dummy plate and the second dummy plate.

12. The method of claim 11, wherein the original plate for manufacturing the first light guide panel includes a plurality of unit light guide panels, and the first dummy plate includes a plurality of unit dummy plates that are in a position that corresponds to positions of the unit light guide panels.

13. The method of claim 12, wherein the unit dummy plates are arranged to be spaced apart from each other.

14. The method of claim 11, wherein the cutting lines includes a first cutting line provided in a direction that is parallel to an x-axis and a second cutting line provided in a direction that is parallel to a y-axis.

15. The method of claim 14, wherein a polishing device is inserted between the first cutting line and the second cutting line to polish side surfaces of the unit light guide panels.
